(19) United States
(12) Patent Application Publication
(10) Pub. No.: US 2026/0302379 A1
(43) Pub. Date: Oct. 1, 2026

(54) SOLID ELECTROLYTE MEMBRANE AND ALL-SOLID-STATE RECHARGEABLE BATTERIES

(71) Applicant: SAMSUNG SDI CO., LTD., Yongin-si, Gyeonggi-do (KR)

(72) Inventors: Wonseok CHO, Yongin-si, Gyeonggi-do (KR); Inyeong KANG, Yongin-si, Gyeonggi-do (KR); Jinhwan PARK, Yongin-si, Gyeonggi-do (KR); Kyusung PARK, Yongin-si, Gyeonggi-do (KR)

(73) Assignee: SAMSUNG SDI CO., LTD., Yongin-si, Gyeonggi-do (KR)

(21) Appl. No.: 18/880,450

(22) PCT Filed: Jan. 9, 2024
(86) PCT No.: PCT/KR2024/000421

§ 371 Date: Dec. 31, 2024

(30) Foreign Application Priority Data
May 24, 2023 (KR) 10-2023-0067185

(51) Int. Cl. H01M 10/42; H01M 10/0562; H01M 50/411

(52) U.S. Cl. CPC H01M 10/4235; H01M 10/0562; H01M 50/411; H01M 2300/0068

(57) ABSTRACT

Disclosed are a solid electrolyte membrane and an all-solid-state rechargeable battery, the solid electrolyte membrane including a sulfide-based solid electrolyte and an additive, wherein the additive includes an organic compound including a radical initiating functional group.

### TECHNICAL FIELD

Solid electrolyte membranes and all-solid-state rechargeable batteries are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries, and can reduce the thickness of the negative electrode, improving high-rate charging and discharging performance, and realizing high-voltage driving and high energy density.

### DISCLOSURE

Provided are solid electrolyte membranes that can block ion currents and induce battery shutdown by forming a film at high temperature during an abnormal reaction in an all-solid-state rechargeable battery, and an all-solid-state rechargeable battery with improved safety and reliability.

In an embodiment, a solid electrolyte membrane includes a sulfide-based solid electrolyte and an additive, wherein the additive comprises an organic compound including a radical initiating functional group.

Some embodiments provide an all-solid-state rechargeable battery including a positive electrode, a negative electrode, and the solid electrolyte membrane between the positive electrode and the negative electrode

The solid electrolyte membrane according to an embodiment form a film when the temperature rises due to an abnormal reaction of the battery, blocking ion current and inducing shutdown of the battery, thereby improving safety and reliability of the all-solid-state rechargeable battery.

### DESCRIPTION OF THE DRAWINGS

FIGS. 1 and 2 are cross-sectional views schematically showing all-solid-state rechargeable batteries according to an embodiment.

FIG. 3 is a differential scanning calorimetry (DSC) graph for Reference Example 1 and Comparative Reference Example 1.

FIG. 4 show images taken after the solutions of Reference Example 1 and Comparative Reference Example 1 were each heated to 180° C.

FIG. 5 is a graph showing the change in ionic conductivity before and after heating the solid electrolyte membrane manufactured in Example 1 and Comparative Example 1 at 180° C. for 30 minutes.

FIG. 6 is cycle-life characteristic evaluation graph for the all-solid-state rechargeable battery cells of Example 1 and Comparative Example 1.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

As used herein, when specific definition is not otherwise provided, “substituted” refers to replacement of at least one hydrogen by a substituent of a halogen atom (F, Cl, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

### Solid Electrolyte Membrane

In an embodiment, a solid electrolyte membrane includes a sulfide-based solid electrolyte and an additive, wherein the additive includes an organic compound including a radical initiating functional group.

### Additive

The additive may form a film through a polymerization reaction and the like, when a temperature rises due to Joule heat situations such as penetration, a short circuit, or the like of a battery, to block an ion current and thus induce a shutdown. The additive may begin a reaction for forming the film, for example, at greater than or equal to 110° C. or greater than or equal to 120° C. and thus form the film at a lower temperature than 180° C., a melting point of lithium metal, to effectively suppress desorption or permeation of liquid lithium. The additive may form the film at 110° C. to 180° C., for example, 130° C. to 180° C., 140° C. to 180° C., or 150° C. to 179° C. The additive may be expressed as a film-forming additive, a shutdown additive, or the like.

The additive has almost no reactivity with a sulfide-based solid electrolyte in the solid electrolyte membrane and thus does not deteriorate the solid electrolyte, and because the film may be formed even in a small amount of the additive, ionic conductivity of the solid electrolyte membrane may not be deteriorated, but high-temperature safety may be improved without deteriorating performance. The additive may be dispersed in the solid electrolyte membrane and thus act as a type of dispersant or have no influence on the solid electrolyte membrane during normal reaction or battery operation but when the battery is subjected to high temperature conditions by abnormal reaction, form the film to perform a shutdown function.

In the organic compound including the radical initiating functional group, the radical initiating functional group may be, for example, an azo group (—N═N—), a peroxide group (—O—O—), or a combination thereof, but is not limited thereto. The radical initiating functional group may react with organic substances within the solid electrolyte membrane under high temperature conditions, for example, in the temperature range of 110° C. to 180° C., to induce a polymerization reaction and induce film formation.

The organic compound including the radical initiating functional group may include various organic groups in addition to the radical initiating functional group. Here, the organic group is a group including carbon and hydrogen, and may mean an organic functional group having 1 to 100 carbon atoms or 1 to 50 carbon atoms. The organic group may help the organic compound including the radical initiating functional group to be evenly dispersed within the solid electrolyte membrane, and may play a role in increasing miscibility with organic substances such as an organic dispersant or binder within the solid electrolyte membrane. For example, the organic group may be a hydrophobic functional group. That is, the organic compound including the radical initiating functional group may further include a hydrophobic group, in which case the organic compound has high miscibility with organic substances such as an organic dispersant or binder in the solid electrolyte membrane, so that it can be uniformly dispersed in the membrane and a film can be effectively formed even with a small amount.

The organic group may be for example a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a combination thereof.

For example, the organic group may be a substituted or unsubstituted C1 to C20 alkyl group, a substituted or unsubstituted C3 to C20 cycloalkyl group, a substituted or unsubstituted C6 to C20 aryl group, an ester group, an ether group, a cyano group, or a combination thereof.

The organic group may include hetero elements such as N, O, S, P, Si, B, etc. in addition to carbon and hydrogen, and may include a halogen element such as F, Cl, Br, I, etc., and may include Li, Na, K, Mg, Ca, Cs, Ba, Cu, Zn, Ag, In, Sb, Co, Fe, Mn, Pd, etc.

The aryl group may be a functional group including an aromatic ring or a functional group derived from an aromatic ring, for example, phenyl, benzyl, benzoyl, pyriline, pyrrole, naphthalene, phenanthrene, or a derivative thereof.

The organic compound including the radical initiating functional group may be represented by, for example, Chemical Formula 1.

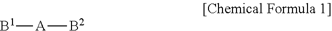

In Chemical Formula 1, A is a radical initiating functional group such as an azo group or a peroxide group, and B¹ and B² correspond to an organic group, are the same as or different from each other, and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a combination thereof.

In Chemical Formula 1, B¹ and B² may be, for example, a substituted or unsubstituted C1 to C20 alkyl group, a substituted or unsubstituted C3 to C20 cycloalkyl group, a substituted or unsubstituted C6 to C20 aryl group, an ester group, an ether group, a cyano group, or a combination thereof.

For example, the organic compound including the radical initiating functional group may be represented by Chemical Formula 2 or Chemical Formula 3.

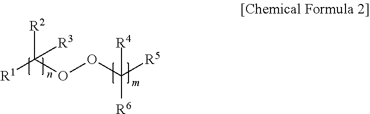

In Chemical Formula 2, R¹ to R⁶are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof, and n and m are integers from 1 to 20,

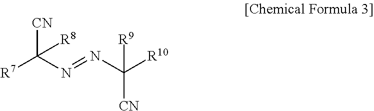

wherein, in Chemical Formula 3, R⁷ to R¹⁰ are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof.

The compound represented by Chemical Formula 3 may be represented, for example, by Chemical Formula.

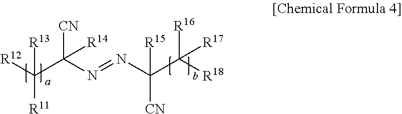

In Chemical Formula 4, R¹¹ to R¹⁸ are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof, and a and b are integers from 1 to 20.

For example, the organic compound including the radical initiating functional group may be represented by Chemical Formula 5.

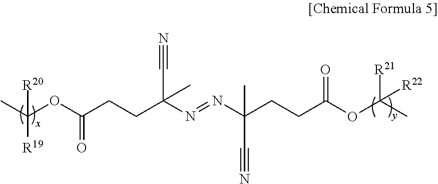

In the above chemical formula 5, R19 to R22 are the same as or different from each other and are each independently hydrogen, or a substituted or unsubstituted C1 to C6 alkyl group, and x and y are integers of 0 to 20.

The organic compound including the radical initiating functional group may be at least one selected from the following compounds as specific examples, but is not limited thereto.

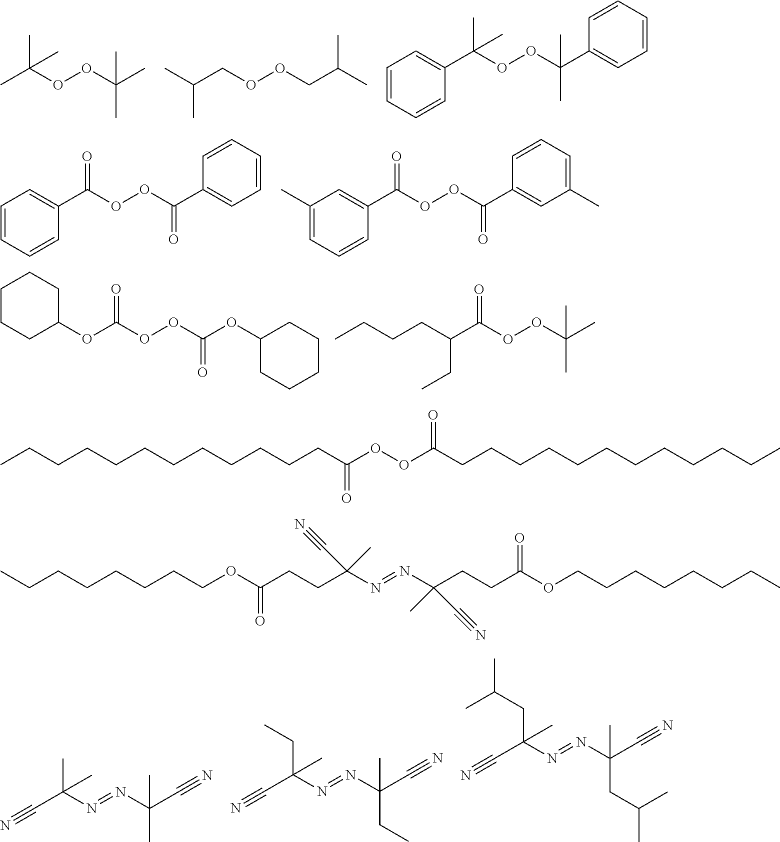

The additive may be included in an amount of 0.1 wt % to 10 wt %, for example, 0.1 wt % to 8 wt %, 0.1 wt % to 6 wt %, 0.1 wt % to 5 wt %, 0.1 wt % to 3 wt %, 0.1 wt % to 2 wt %, 0.2 wt % to 1.5 wt %, 0.3 wt % to 1.0 wt %, or 0.5 wt % to 0.9 wt % based on 100 wt % of the solid electrolyte membrane. Even a small amount of additive can be evenly dispersed in the solid electrolyte membrane and effectively form a film under high temperature conditions to induce shutdown.

### Sulfide-Based Solid Electrolyte

The sulfide-based solid electrolyte may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S-GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity may be prepared. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte particles according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte particles may include argyrodite-type sulfide. The argyrodite-type sulfide-based solid electrolyte may have high ionic conductivity close to the range of 10-4 to 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

For example, the argyodite-type sulfide-based solid electrolyte particles may include a compound represented by Chemical Formula 11.

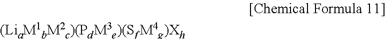

In Chemical Formula 11, 4≤a≤8, M¹ is Mg, Cu, Ag, or a combination thereof, 0≤b<0.5, M² is Na, K, or a combination thereof, 0≤c<0.5, M³ is Sn, Zn, Si, Sb, Ge, or a combination thereof, 0<d<4, 0≤e<1, M⁴ is O, SOₙ, or a combination thereof, 1.5<n≤5, 3≤f≤12, 0≤g<2, X is F, Cl, Br, I, or a combination thereof, and 0≤h≤2.

For example, the halide element (X) may be necessarily included in Chemical Formula 11, and in this case, it may be expressed as 0<h≤2. For example, M¹ element may be necessarily included in Chemical Formula 11, and in this case, it may be expressed as 0<b<0.5. In Chemical Formula 11, M³ may be understood as an element substituted for P and may be 0<e<1. In Chemical Formula 11, M⁴ is substituted for S, for example may be 0<g<2, and f, a ratio of S, may be for example 3≤f≤7. If M⁴ is SOₙ, SOₙ may be for example S₄O₆, S₃O₆, S₂O₃, S₂O₄, S₂O₅, S₂O₆, S₂O₇, S₂O₈, SO₄, SO₅, and the like.

For example, in Chemical Formula 11, a+b+c+h=7, d+e=1, and f+g+h=6.

As an example, the argyrodite-type sulfide-based solid electrolyte particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60} (SO₄)_{0.15}) Cl_{1.25}, (Li_{5.72}Cu_{0.03})P(S_{4.725}(SO₄)_{0.025})Cl_{1.25}, (Li_{5.72}Na_{0.03})P(S_{4.725} (SO₄)_{0.025})Cl_{1.25}, Li_{5.75}P(S_{4.725}(SO₄)_{0.025})Cl_{1.25}, or a combination thereof, but is not limited thereto.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Herein, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

An average particle diameter (D50) of the sulfide-based solid electrolyte particles may be for example 0.1 μm to 5.0 μm or 0.1 μm to 3.0 μm, or the sulfide-based solid electrolyte particles may be small particles of 0.1 μm to 1.9 μm or large particles of 2.0 μm to 5.0 μm. The sulfide-based solid electrolyte particles may be a mixture of small particles with an average particle diameter of 0.1 μm to 1.9 μm and large particles with an average particle diameter of 2.0 μm to 5.0 μm. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

### Organic Dispersant

The solid electrolyte membrane according to an embodiment may further include an organic dispersant in addition to the sulfide-based solid electrolyte and the additive described above. The organic dispersant may play a role in dispersing components well within a solid electrolyte membrane. The aforementioned additive may react with this organic dispersant to form a film. For example, the radical initiating functional group of the additive may form a film by causing a polymerization reaction with the organic dispersant when decomposed under high temperature conditions. Furthermore, the additive includes an organic group other than a radical initiating functional group, and because this organic group has high miscibility with the organic dispersant, it can be evenly dispersed within the solid electrolyte membrane.

The organic dispersant may be a nonionic polymer, for example a nonionic polymer having functional groups such as an ester, an alkylester, an alkylene glycol, an alkylene, an amide, an imide, and/or an acrylate. Here, the alkylene glycol may be, for example, ethylene glycol, and the alkylene may be ethylene, propylene, etc. For example, the organic dispersant may be a polyalkyl ester, a polyalkylene glycol, a polyethylene, a polypropylene, a polyamideimide, a polyimide, a poly(meth)acrylate, a copolymer thereof, or a combination thereof.

The organic dispersant may be included in an amount of 0.1 wt % to 10 wt %, for example, 0.1 wt % to 8 wt %, 0.1 wt % to 6 wt %, 0.1 wt % to 5 wt %, 0.1 wt % to 3 wt %, 0.5 wt % to 2 wt %, or 0.5 wt % to 1.5 wt % based on 100 wt % of the solid electrolyte membrane. If the content of the organic dispersant is excessive, the ionic conductivity of the solid electrolyte membrane may decrease, and if the content is too small, the dispersibility of the components may decrease, which may lower durability and battery reliability.

A weight ratio of the additive to the organic dispersant in the solid electrolyte membrane may be 10:90 to 90:10, for example 20:80 to 80:20, 30:60 to 70:30, or 40:60 to 60:40. In this case, the additive can be well dispersed in the solid electrolyte membrane due to its compatibility with the organic dispersant, and can also react with the organic dispersant under high temperature conditions to effectively form a film, thereby inducing early shutdown.

### Binder

The solid electrolyte membrane according to an embodiment may further include a binder. For example, the binder may include a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of 0.1 wt % to 3 wt %, for example 0.5 wt % to 2 wt %, or 0.5 wt % to 1.5 wt % based on 100 wt % of the solid electrolyte membrane. If the binder is included in the above range, the components in the solid electrolyte membrane can be well combined without reducing the ionic conductivity of the solid electrolyte, thereby improving the durability and reliability of the battery.

### Other Components

The solid electrolyte membrane may include an oxide-based inorganic solid electrolyte in addition to the sulfide-based solid electrolyte. For example, the oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; x is an integer of 1 to 10), or a mixture thereof.

For example, the solid electrolyte membrane may further include a halide-based solid electrolyte. The halide-based solid electrolyte includes a halogen element as a main component, meaning that a ratio of the halide element to all elements constituting the solid electrolyte may be greater than or equal to 50 mol %, greater than or equal to 70 mol %, greater than or equal to 90 mol %, or 100 mol %. For example, the halide-based solid electrolyte may not include a sulfur element.

The halide-based solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof and for example it may be Cl, Br, or a combination thereof. For example, the halide-based solid electrolyte may be LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). For example, the halide-based solid electrolyte may include Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof, but is not limited thereto.

The solid electrolyte membrane may optionally further include an alkali metal salt, and/or an ionic liquid, and/or a conductive polymer.

For example, the alkali metal salt may be lithium salt. A content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may be applied without type limitations, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato) borate (LiBOB), lithium difluorobis (oxalato) borate (LiDFOB), lithium difluorobis(oxalato)phosphate (LiDFBP), lithium bis(trifluoromethanesulfonyl)imide (LiTFSI), lithium bis(fluorosulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide-based lithium salt such as LiTFSI, LiFSI, LiBETI, or a combination thereof. The imide-based lithium salt may maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl-, Br-, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The solid electrolyte membrane according to an embodiment may be a membrane with guaranteed high-temperature safety, in which a film is formed and a shutdown is induced when heat is generated due to an abnormal reaction of the battery. The solid electrolyte membrane may include a film within the membrane when subjected to high temperature conditions, for example, temperatures of 110° C. or higher, 130° C. or higher, or 160° C. or higher. The film may be formed by a polymerization reaction of the aforementioned additive or by a polymerization reaction of the additive and an organic dispersant.

### All-Solid-State Rechargeable Battery

In an embodiment, an all-solid-state rechargeable battery includes a positive electrode, a negative electrode, and the aforementioned solid electrolyte membrane between the positive electrode and the negative electrode.

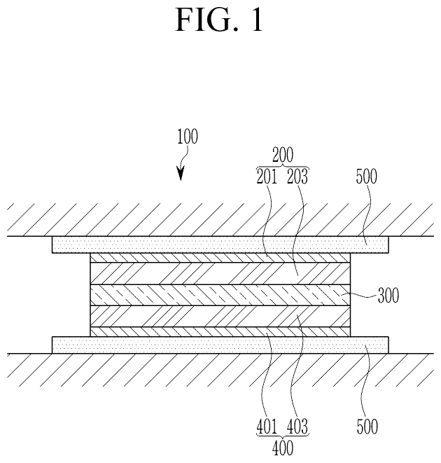

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Negative Electrode

A negative electrode for an all-solid-state rechargeable battery includes a current collector and a negative electrode active material layer on the current collector. The negative electrode active material layer may include a negative electrode active material, may further include binder and/or conductive material, may optionally include the aforementioned solid electrolyte.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

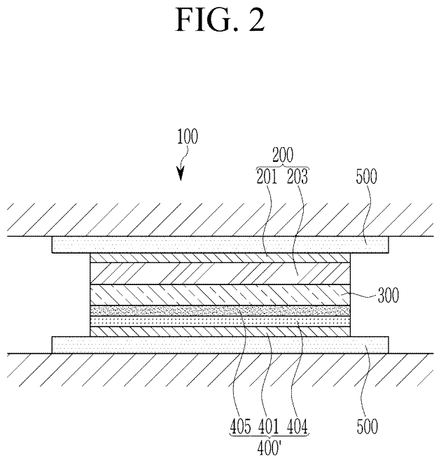

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned region or first solid electrolyte layer may be referred to as a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material. At this time, the positive electrode active material layer may include the solid electrolyte described above.

### Positive Electrode Active Material

The positive electrode active material may be applied without limitation as long as it is generally used in all-solid-state rechargeable batteries. For example, the positive electrode active material may be a compound being capable of intercalating and deintercalating lithium, may include a lithium transition metal composite oxide, and may include a compound represented by one of the following chemical formulas.

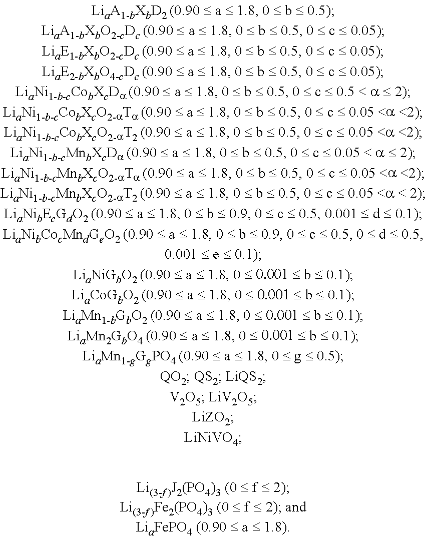

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

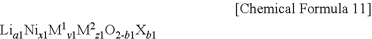

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

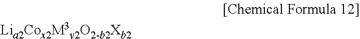

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

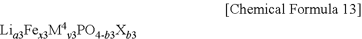

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

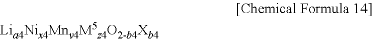

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Evaluation Example 1

First, for a film formation test, a nonionic polymer including alkylester and ethylene glycol functional groups as an organic dispersant was dissolved in an isobutyryl isobutyrate (IBIB) solvent to prepare a solution of Comparative Reference Example 1. In the solution of Comparative Reference Example 1, an additive represented by the following chemical formula was added thereto in the same content as that of the organic dispersant to prepare a solution of Reference Example 1.

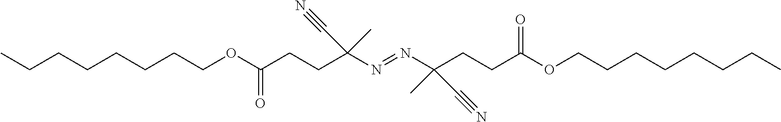 [SMILES: CCCCCCCCOC(=O)CCC(C)(C#N)/N=N/C(C)(C#N)CCC(=O)OCCCCCCCC]

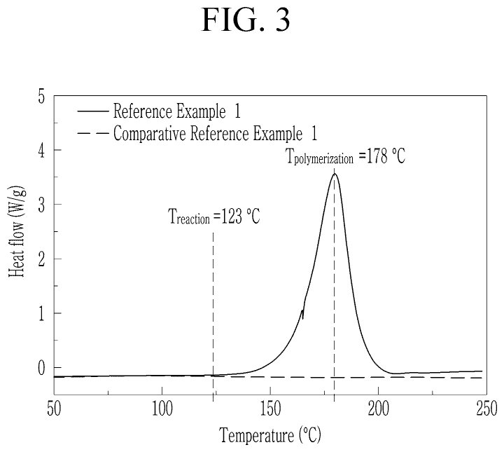

Comparative Reference Example 1 and Reference Example 1 were subjected to differential scanning calorimetry (DSC), and the results are shown in FIG. 3. Referring to FIG. 3, Comparative Reference Example 1 showed no changes to 250° C., but Reference Example 1 was confirmed that a polymerization reaction occurred at about 178° C.

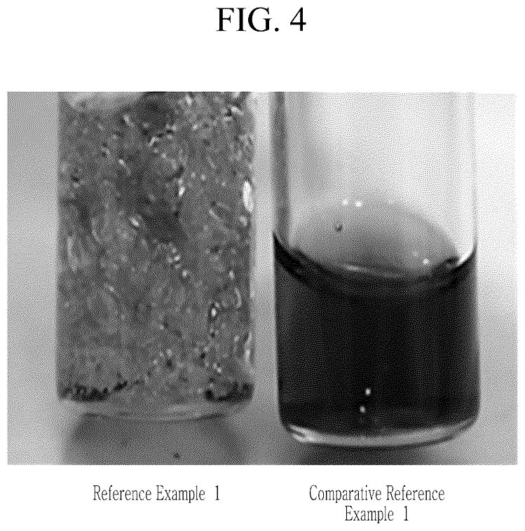

In addition, the solution of Comparative Reference Example 1 and the solution of Reference Example 1 were respectively heated to 180° C. to check changes, which were shown in FIG. 4. Referring to FIG. 4, Reference Example 1 was confirmed with naked eyes that the reaction occurred.

### Example 1

### 1. Manufacturing of Solid Electrolyte Membrane

0.67 wt % of the organic dispersant used in Reference Example 1 and 0.67 wt % of the additive used in Reference Example 1, and 0.66 wt % of an acrylic copolymer (SX-A334, Zeon Chemicals L.P.) as a binder were added to an IBIB solvent, and 98 wt % of a solid electrolyte (Li₆PS₅Cl, D50=3.5 μm) was added thereto to prepare a composition for a solid electrolyte membrane. The composition was applied onto a PET release film with a blade coater, pre-dried at about at 50° C., and dried at about 70° C. under vacuum to form a solid electrolyte membrane with a thickness of about 100 μm to 150 μm.

2. Manufacturing of all-Solid-State Rechargeable Battery Cell

Carbon black with a primary particle diameter (D50) of about 30 nm and silver (Ag) with an average particle diameter (D50) of about 60 nm were mixed in a weight ratio of 3:1 to prepare a Ag/C composite, and 0.25 g of the composite was added to 2 g of an NMP solution including 7 wt % of a polyvinylidene fluoride binder to prepare a negative electrode coating layer composition. The negative electrode coating layer composition was coated on a nickel foil current collector with a bar coater and then, vacuum-dried to form a negative electrode coating layer on the current collector, preparing a precipitation-type negative electrode.

A positive electrode composition was prepared by mixing 85 wt % of LiNi_{0.8}Co_{0.15}Mn_{0.05}O₂ coated with Li₂O—ZrO₂ as a positive electrode active material, 13.5 wt % of Li₆PS₅Cl as a solid electrolyte, 1.0 wt % of a polyvinylidene fluoride as a binder, and 0.5 wt % of carbon nanotube as a conductive material. The prepared positive electrode composition was coated on a positive electrode current collector with a bar coater and then, dried and compressed to manufacture a positive electrode.

The solid electrolyte membrane was stacked on the negative electrode, and the positive electrode was stacked thereon to manufacture a unit cell, which was inserted into a laminate film and then, subjected to warm isostatic press (WIP) at 80° C. for 30 minutes at 500 MPa to manufacture an all-solid-state rechargeable battery cell.

### Example 2

A solid electrolyte membrane and an all-solid-state rechargeable battery cell were manufactured substantially in the same manner as in Example 1 except that the additive was used instead of the compound represented by the following chemical formula in manufacturing the solid electrolyte membrane.

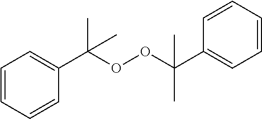 [SMILES: CC(C)(OOC(C)(C)c1ccccc1)c1ccccc1]

### Example 3

A solid electrolyte membrane and an all-solid-state rechargeable battery cell were manufactured substantially in the same manner as in Example 1 except that the additive was used instead of the compound represented by the following chemical formula in manufacturing the solid electrolyte membrane.

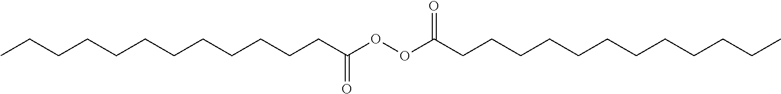 [SMILES: CCCCCCCCCCCCC(=O)OOC(=O)CCCCCCCCCCCC]

### Comparative Example 1

A solid electrolyte membrane and an all-solid-state rechargeable battery cell were manufactured substantially in the same manner as in Example 1 except that the additive was not used in manufacturing the solid electrolyte membrane.

### Evaluation Example 2

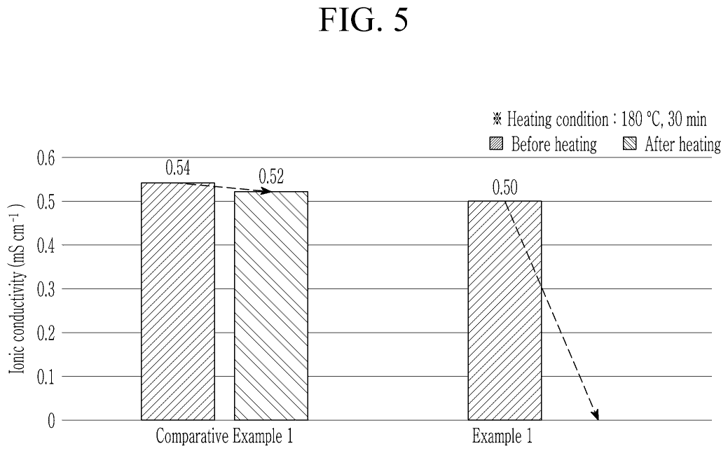

The solid electrolyte membrane of Example 1 and the solid electrolyte membrane of Comparative Example 1 were subjected to an experiment of heating at 180° C. for 30 minutes to measure ionic conductivity changes before and after the heating, and the results are shown in FIG. 5 and Table 1.

TABLE 1

| | | | Ionic |
|---|---|---|---|
| | | | conductivity |
| | Comparative | | retention |
| | Example 1 | Example 1 | rate (%) |
| Before heating | 0.54 mScm⁻¹ | 0.50 mScm⁻¹ | 92 |
| After heating | 0.52 mScm⁻¹ | 0 mScm⁻¹ | — |

Referring to FIG. 5 and Table 1, Example 1 which was heated at 180° C., was confirmed that a film was formed in the solid electrolyte membrane, thereby inducing a shutdown and successfully reducing ionic conductivity to 0. In addition, before the heating, a retention rate of the ionic conductivity of the solid electrolyte membrane of Example 1 to the ionic conductivity of the solid electrolyte membrane of Comparative Example 1 was maintained at 92% or so. This means that even if the additive was added in the example, the ionic conductivity was not significantly reduced but maintained at 92% or so, which was almost equivalent to that of Comparative Example 1.

### Evaluation Example 3: Evaluation of Battery Cell Cycle-Life Characteristics

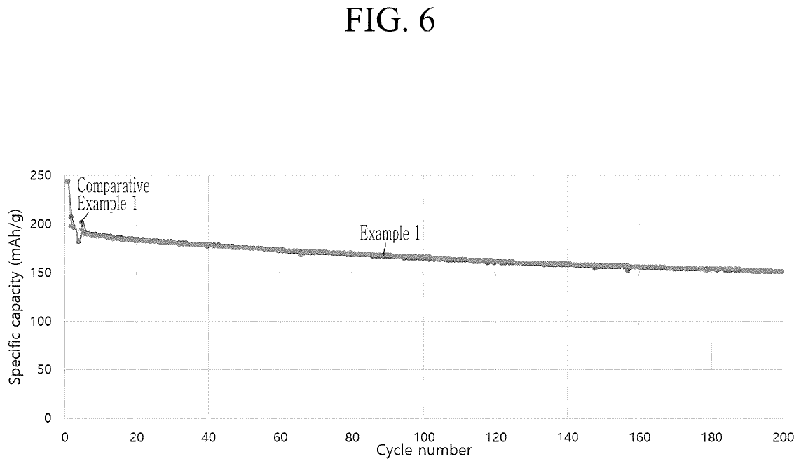

The battery cells of Example 1 and Comparative Example 1 were charged to an upper limit voltage of 4.25 V at a constant current of 0.1 C and to 0.05 C at the constant voltage and then, discharged to a cut-off voltage of 2.5 V at 0.1 C at 45° C. for initial charge and discharge. Subsequently, the battery cells were repetitively 200 cycles charged and discharged at 0.33 C within a voltage range of 2.5 V to 4.25 V at 45° C. to evaluate cycle-life characteristics, and then, discharge capacity according to the number of cycles is shown in FIG. 6, and a ratio of discharge capacity at the 200th cycle to initial discharge capacity as capacity retention rate is shown in Table 2.

TABLE 2

| | 200th cycle |
|---|---|
| | capacity |
| | retention |
| | rate (%) |
| Comparative | 74.6 |
| Example 1 | |
| Example 1 | 79.7 |

Referring to FIG. 6 and Table 2, the all-solid-state rechargeable battery cell of Example 1 exhibited improved cycle-life characteristics, compared with the cell of Comparative Example 1.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
400': precipitation-type negative electrode
404: lithium metal layer
405: negative electrode coating layer
500: elastic layer

1. A solid electrolyte membrane, comprising
a sulfide-based solid electrolyte and an additive,
wherein the additive comprises an organic compound including a radical initiating functional group.

2. The solid electrolyte membrane as claimed in claim 1, wherein
the radical initiating functional group is an azo group (—N═N—), a peroxide group (—O—O—), or a combination thereof.

3. The solid electrolyte membrane as claimed in claim 1, wherein
the organic compound including the radical initiating functional group is represented by Chemical Formula 1: 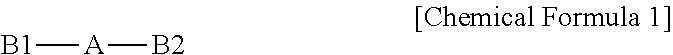
wherein in Chemical Formula 1,
A is an azo group or a peroxide group, and
B1 and B2 are the same as or different from each other, and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a combination thereof.

4. The solid electrolyte membrane as claimed in claim 3, wherein
in Chemical Formula 1, B1 and B2 are each independently a substituted or unsubstituted C1 to C20 alkyl group, a substituted or unsubstituted C3 to C20 cycloalkyl group, a substituted or unsubstituted C6 to C20 aryl group, an ester group, an ether group, a cyano group, or a combination thereof.

5. The solid electrolyte membrane as claimed in claim 1, wherein
the organic compound including the radical initiating functional group is represented by Chemical Formula 2 or Chemical Formula 3: 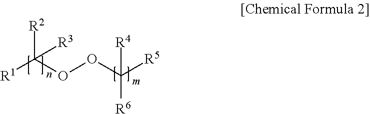
wherein in Chemical Formula 2, R1 to R6 are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof, and n and m are integers from 1 to 20, 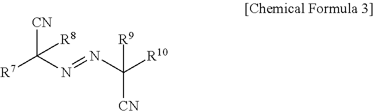
wherein in Chemical Formula 3, R7 to R10 are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof.

6. The solid electrolyte membrane as claimed in claim 1, wherein
the organic compound including the radical initiating functional group is represented by Chemical Formula 4: 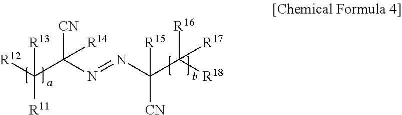
wherein in Chemical Formula 4, R11 to R18 are the same as or different from each other and are each independently a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, an ester group, an ether group, a carboxyl group or a salt thereof, or a combination thereof, and a and b are integers from 1 to 20.

7. The solid electrolyte membrane as claimed in claim 1, wherein
the organic compound including the radical initiating functional group is represented by Chemical Formula 5: 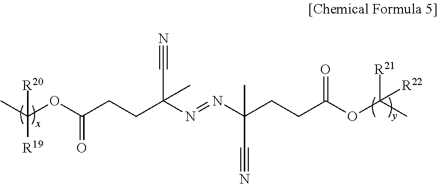
wherein in Chemical Formula 5, R19 to R22 are the same as or different from each other and are each independently, or a substituted or unsubstituted C1 to C6 alkyl group, and x and y are integers of 0 to 20.

8. The solid electrolyte membrane as claimed in claim 1, wherein
the organic compound including the radical initiating functional group further comprises a hydrophobic group.

9. The solid electrolyte membrane as claimed in claim 1, wherein
the organic compound including the radical initiating functional group is at least one selected from the following compounds:

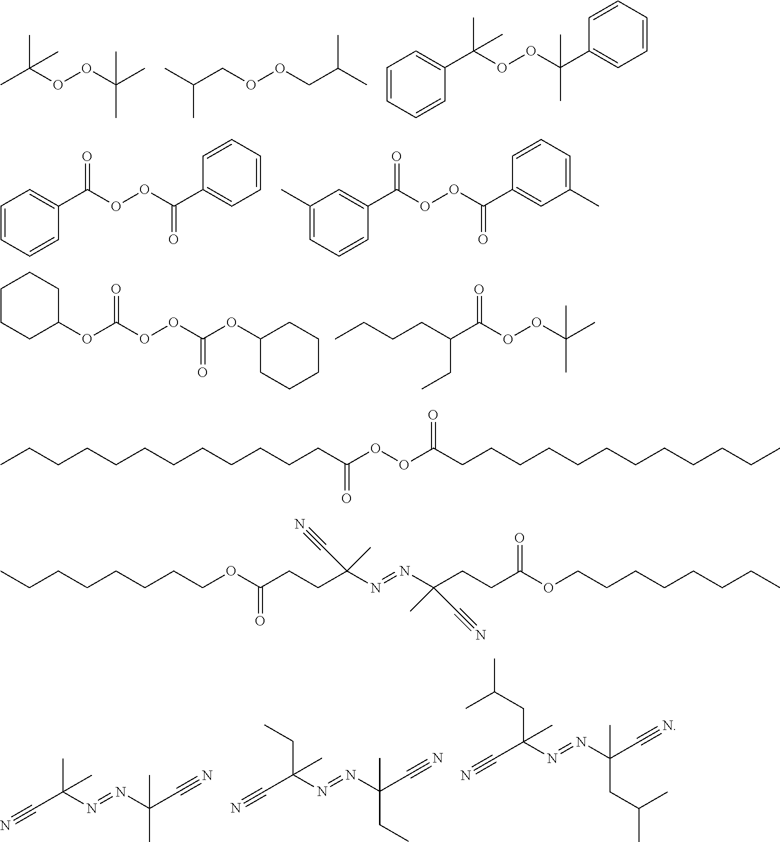

10. The solid electrolyte membrane as claimed in claim 1, wherein the additive forms a film in a temperature range of 110° C. to 180° C.

11. The solid electrolyte membrane as claimed in claim 1, wherein
the additive is included in an amount of 0.1 wt % to 10 wt % based on 100 wt % of the solid electrolyte membrane.

12. The solid electrolyte membrane as claimed in claim 1, wherein
the additive is included in an amount of 0.1 wt % to 5 wt % based on 100 wt % of the solid electrolyte membrane.

13. The solid electrolyte membrane as claimed in claim 1, wherein
the above sulfide-based solid electrolyte is in a form of particles and an average particle diameter of the particles is 0.1 μm to 5.0 μm.

14. The solid electrolyte membrane as claimed in claim 1, wherein
the sulfide-based solid electrolyte comprises an argyrodite-type sulfide represented by Chemical Formula 11: 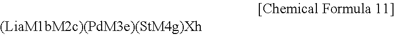
wherein in Chemical Formula 11,
4≤a≤8,
M1 is Mg, Cu, Ag, or a combination thereof, 0≤b<0.5,
M2 is Na, K, or a combination thereof, 0≤c<0.5,
M3 is Sn, Zn, Si, Sb, Ge, or a combination thereof, 0<d<4, 0≤e<1,
M4 is O, SOn, or a combination thereof, 1.5≤n≤5, 3≤f≤12, 0≤g<2, and
X is F, Cl, Br, I, or a combination thereof, 0≤h≤2.

15. The solid electrolyte membrane as claimed in claim 1, wherein
the solid electrolyte membrane comprises a film formed by the additive at a temperature range of 110° C. to 200° C.

16. The solid electrolyte membrane as claimed in claim 1, wherein the solid electrolyte membrane further comprises an organic dispersant.

17. The solid electrolyte membrane as claimed in claim 16, wherein:
the organic dispersant comprises a nonionic polymer; and/or
the organic dispersant is included in an amount of 0.1 wt % to 10 wt % based on 100 wt % of the solid electrolyte membrane; and/or
a weight ratio of the additive and the organic dispersant is 10:90 to 90:10.

18. (canceled)

19. (canceled)

20. The solid electrolyte membrane as claimed in claim 16, wherein
the solid electrolyte membrane comprises a film formed by a reaction of the additive and the organic dispersant in a temperature range of 110° C. to 200° C.

21. An all-solid-state rechargeable battery comprising
a positive electrode,
a negative electrode, and
the solid electrolyte membrane as claimed in claim 1 between the positive electrode and the negative electrode.

22. The all-solid-state rechargeable battery as claimed in claim 21, wherein the negative electrode comprises a current collector and a negative electrode coating layer disposed on the current collector and including a lithiophilic metal, a carbon material, or a combination thereof, and
a lithium metal layer formed by charging between the current collector and the negative electrode coating layer.
